(19) United States
(12) Patent Application Publication
(10) Pub. No.: US 2026/0328190 A1
(43) Pub. Date: Oct. 22, 2026

(54) TEMPERATURE AND VOLTAGE MONITORING RELAY

(71) Applicant: Richardson Electronics, Ltd., LaFox, IL (US)

(72) Inventors: Caleb Dean, LaFox, IL (US); Jeremy Winston Wilks, LaFox, IL (US); John Raymond Curran, LaFox, IL (US)

(21) Appl. No.: 19/655,426

(22) Filed: Apr. 22, 2026

Related U.S. Application Data
(60) Provisional application No. 63/792,665, filed on Apr. 22, 2025.

(51) Int. Cl. F03D 17/00; F03D 80/60

(52) U.S. Cl. CPC F03D 17/002; F03D 17/018; F03D 17/021; F03D 80/60; F05B 2260/83

(57) ABSTRACT

A monitoring relay system and device operable to remotely monitor a temperature and/or voltage associated with a wind turbine. The relay system and device may comprise remote and manual test actuator operable to initiate a test remotely or manually. The relay system and device may further be operable to communicate wirelessly to provide monitoring information remotely to an operator in a remote location or to receive control adjustments remotely.

### RELATED APPLICATIONS

This non-provisional patent application claims priority benefit, with regard to all common subject matter, of earlier-filed U.S. Provisional Patent Application No. 63/792,665, filed on Apr. 22, 2025, and entitled “TEMPERATURE AND VOLTAGE MONITORING RELAY.” The identified earlier-filed provisional patent application is hereby incorporated by reference in its entirety into the present application.

### BACKGROUND

### 1. Field

Embodiments of the invention relate to temperature and voltage monitoring. More specifically, embodiments of the invention relate to monitoring relay systems for use in wind turbines.

### 2. Related Art

Monitoring systems such as temperature monitoring relays and voltage monitoring relays of wind turbines are used to monitor vital system parameters of the wind turbine to ensure safe operation. However, existing monitoring systems are typically limited to manual operation such that operators must enter the wind turbine compartment, for example, to program relay set points and to analyze relay data.

### SUMMARY

Embodiments of the invention solve the above-mentioned problems by providing systems, methods, and devices for remotely monitoring wind turbine components. In some embodiments, a temperature signal relay is contemplated that is operable to remotely monitor temperature within a compartment of a wind turbine. In some embodiments, a voltage signal relay is contemplated that is operable to remotely monitor at least one voltage associated with the wind turbine.

In some aspects, the techniques described herein relate to a monitoring system for a wind turbine. The monitoring system is configured to be disposed in a compartment of the wind turbine. The monitoring system includes one or more temperature sensors operable to measure a temperature within the compartment of the wind turbine, one or more connections operable to interface with the compartment of the wind turbine, and a manual test trigger operable to initiate a test routine of the monitoring system. The monitoring system is operable to receive a remote test input to initiate the test routine of the monitoring system and remotely receive one or more temperature set points.

In some aspects, the techniques described herein relate to a monitoring system for a wind turbine. The monitoring system is configured to be disposed in a compartment of the wind turbine. The monitoring system includes one or more voltage sensors operable to measure a voltage within the compartment of the wind turbine, and one or more connections operable to interface with the compartment of the wind turbine. The monitoring system is operable to receive one or more voltage set points.

In some aspects, the techniques described herein relate to a monitoring system for a wind turbine. The monitoring system is configured to be disposed in a compartment of the wind turbine. The monitoring system includes one or more temperature sensors operable to measure a temperature within the compartment of the wind turbine, one or more voltage sensors operable to measure a voltage within the compartment of the wind turbine, and one or more connections operable to interface with the compartment of the wind turbine. The monitoring system is operable to receive one or more temperature set points and one or more voltage set points.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIGS. 1A-1D depict various views of an exemplary relay system 10 relating to some embodiments of the present disclosure with FIG. 1A illustrating an isometric view, FIG. 1B illustrating a front view, FIG. 1C illustrating a side view, and FIG. 1D illustrating a top view, and

FIG. 2 illustrates an exemplary operational system diagram relating some embodiments of the present disclosure.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Aspects of the present disclosure provide monitoring systems operable to monitor wind turbine parameters. In some embodiments, the monitoring systems described herein are operable to communicate remotely such that monitoring data may be communicated remotely without the need for onsite inspection or adjustment. Further, in some embodiments, the monitoring systems described herein are operable to receive set points and other programming updates remotely.

In some embodiments, a relay system is provided to replace one or more existing turbine temperature monitoring system components. Additionally, or alternatively, in some embodiments, a relay system is provided to replace existing turbine voltage monitoring system components. For example, a relay system may be provided that uses existing connection interfaces present within a wind turbine compartment.

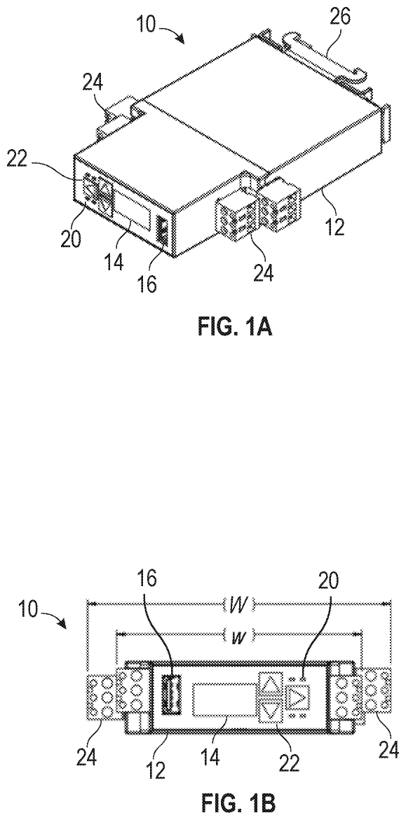

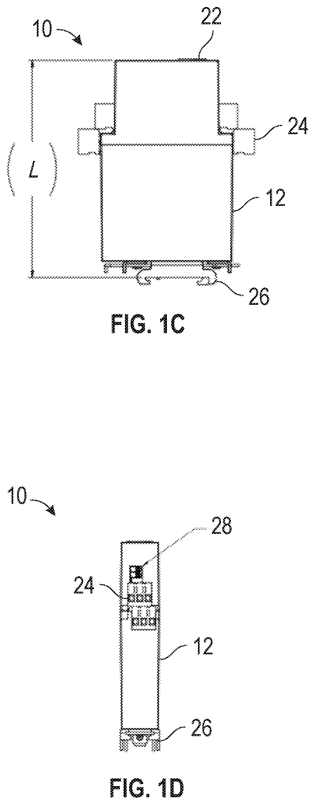

FIGS. 1A-1D depict various views of an exemplary relay system 10 relating to some embodiments of the present disclosure with FIG. 1A illustrating an isometric view, FIG. 1B illustrating a front view, FIG. 1C illustrating a side view, and FIG. 1D illustrating a top view. In some embodiments, the relay system 10 is configured to be disposed in a compartment of a wind turbine. For example, the relay system 10 may be used to provide at least one of monitoring of temperature or monitoring of voltage within the wind turbine. In some embodiments, the relay system 10 is a monitoring system for monitoring one or more conditions of the wind turbine, such as, temperature, voltage, or a combination thereof. Further, in some embodiments, a monitoring system is included comprising multiple instances of the relay system 10 for redundancy or for monitoring various conditions of the wind turbine. For example, a first relay may be included for monitoring temperature while a second relay is included for monitoring voltage, current, or another electrical condition of the wind turbine.

In some embodiments, the relay system 10 comprises a housing 12. For example, the housing 12 may be formed of a rigid material and configured to secure and support one or more internal components of the relay system 10. In some embodiments, the relay system 10 comprises one or more external components disposed external to the housing 12, for example, as shown in FIG. 1B, which illustrates a front surface of the relay system 10.

In some embodiments, the relay system 10 is sized to fit within a compartment of a wind turbine. For example, in some embodiments, an overall width, W, of the relay system 10 from a first end of connection ports 24 to a second end of connection ports 24 opposite the first end is about 4.15 inches. Alternatively, in some embodiments, the overall width, W, is selected from about 3 inches to about 6 inches. Further, in some embodiments, a width, w, of a main body portion (e.g., the housing 12) is about 3.36 inches. Alternatively, in some embodiments, the width, w, is selected from about 2 inches to about 4 inches.

In some embodiments, the relay system 10 comprises a display 14. The display 14 may be mounted on an external surface of the housing 12, as shown. The display 14, for example, may comprise a liquid crystal display (LCD) screen or thin film transistor (TFT) screen operable to provide a visual readout to operators. For example, in some embodiments, the display 14 is operable to provide a visual representation of various parameters associated with the wind turbine such as any of a current temperature, current voltage, current temperature set point, current voltage set point, another parameter, or combinations thereof. Further, in some embodiments, the display 14 is operable to display an error message or another status indication associated with the wind turbine or the relay system 10. In some embodiments, multiple separate displays are included.

In some embodiments, the relay system 10 comprises at least one programming port 16. The programming port 16 may also be mounted on the external surface of the housing 12, as shown. In some embodiments, the programming port 16 is configured to transmit or receive signals associated with the relay system 10. For example, in some embodiments, the programming port 16 is configured to receive programming signals operable to program the relay system 10 from an external programming device. For example, in some embodiments, an operator that is on-site may use the programming port 16 to interface a programming device with the relay system 10 to select temperature set points for the relay system 10 or to adjust control parameters of the relay system 10. Additionally, or alternatively, in some embodiments, remote programming and monitoring means are contemplated, as described in further detail herein. In some embodiments, the programming port 16 comprises a Universal Serial Bus (USB) interface operable to couple to a USB connector of a programming device.

In some embodiments, the relay system 10 comprises one or more status indicators 20. The status indicators 20 may be disposed on the external surface of the housing 12, as shown, such that the status indicators 20 are visible to an operator to convey status information. For example, in some embodiments, the status indicators 20 are configured to illuminate responsive to a particular status of the relay system 10. In some embodiments, a plurality of status indicators 20 is included with each status indicator of the plurality operable to communicate a distinct status. For example, statuses communicated by the status indicators 20 may include any of a signal connection status, a power status, a temperature out of range status, a temperature in range status, a voltage in range status, or another suitable status or parameter associated with the relay system 10.

In some embodiments, the relay system 10 comprises one or more manual actuators 22. For example, the manual actuators 22 may be disposed on the external surface of the relay system 10, as shown. In some embodiments, the one or more manual actuators 22 are configured to receive manual input from an operator. For example, in some embodiments, a manual input to provide or update a temperature set point or a voltage set point may be provided by the operator through the manual actuators 22.

In some embodiments, the one or more manual actuators 22 includes a manual test trigger operable to initiate a test routine of the relay system 10. For example, if the relay system 10 comprises a temperature signal relay, actuation of the manual test trigger may initiate a test routine that engages a heating system associated with the wind turbine. For example, the heating system may comprise one or more heating elements configured to heat a portion of the wind turbine or a compartment therein. In some embodiments, the manual actuators 22, as described herein, comprise one or more buttons. For example, the manual test trigger may comprise a test button such that an operator on-site is able to press the test button to initiate the test.

In some embodiments, the relay system 10 is operable to test a functionality of the heating system such as the individual heating elements of the wind turbine. For example, the relay system 10 may be operable to control and activate the heating elements and use the one or more temperature sensors to test the operation of the heating elements individually or collectively. In some embodiments, such a heating test may occur responsive to a manual input received onsite (e.g., through the one or more manual actuators 22) or a remote input received from a remote location (e.g., from a remote operator with a remote user device).

In some embodiments, the relay system 10 further comprises one or more connection ports 24. For example, in some embodiments, the connection ports 24 are operable to communicate with one or more external devices. For example, in some embodiments, the connection ports are coupled to any of a temperature sensor, a voltage sensor, or a communication device. Further, in some embodiments, at least one connection port may be coupled to a power source to thereby provide electrical power to the relay system 10.

In some embodiments, the relay system 10 comprises a mounting portion 26. For example, the mounting portion 26 may be operable to support the relay system 10 and mount the relay system 10 within a compartment of a wind turbine. As a specific example, in some embodiments, the mounting portion 26 comprises a DIN connection portion operable to couple to a DIN rail mounting system.

In some embodiments, the mounting portion 26 comprises a DIN mount disposed on a rear surface of the housing 12 operable to interface with a DIN rail. For example, the DIN mount may be coupled to the DIN rail to support the relay system 10 thereon. In some embodiments, an overall length, L, of the relay system 10 from a front side face (i.e., the surface including the one or more manual actuators 22) to the mounting portion 26, as shown in FIG. 1C, is about 5.13 inches. Alternatively, in some embodiments, the overall length, L, is selected from about 4 inches to about 6 inches.

In some embodiments, there are various different mounting orientations contemplated for the relay system 10. For example, in some embodiments, the relay system 10 is mounted within the turbine compartment vertically with the connection ports 24 positioned on a top and bottom of the relay system 10. Alternatively, or additionally, in some embodiments, the relay system 10 is mounted horizontally with the connection ports 24 positioned on respective sides of the relay system 10.

It should be understood that in some embodiments, multiple instances of the relay system 10 may be included. For example, a plurality of relay systems may be stacked together in a vertical or horizontal orientation, as well as a combination thereof such that one or more relay systems are positioned horizontally while one or more other relay systems are positioned vertically. In some embodiments, a monitoring system is contemplated that comprises a plurality of relays or relay systems of different types. For example, in some embodiments, a monitoring system comprises a first monitoring relay for monitoring temperature and a second monitoring relay for monitoring voltage. The first monitoring relay may include any combination of the components described with respect to the relay system 10 along with one or more temperature sensors coupled thereto, while the second monitoring relay includes any combination of the components described with respect to the relay system 10 along with one or more voltage sensors coupled thereto.

In some embodiments, the relay system 10 comprises a remote test input 28. For example, the remote test input 28 may be operable to receive a remote test input to trigger a test routine of the relay system 10 from a remote location. As a specific example, a test routine may include activation of one or more heating elements associated with the relay system 10 and monitoring of a temperature to ensure the one or more heating elements are in working condition. For example, in some embodiments, testing routines may be performed periodically to ensure that temperature control components are working properly for winterization to prevent freezing of electrical components. In some embodiments, the remote test input 28 comprises a 24 volt direct current (DC) input such that a voltage signal to the input triggers the relay system 10.

In some embodiments, the relay system 10 is configured to utilize existing wiring, harnesses, and connectors within the wind turbine. For example, the relay system 10 may be configured to interface into a control system of the wind turbine such as on a DIN connector rail or the like. In some embodiments, the relay system 10 is configured to run on alternating current (AC) power present within the wind turbine. For example, the relay system 10 may comprise a 110-240 volt AC 50-60 Hz power input. In some embodiments, the relay system 10 comprises a 10 Amp “fast” fuse (i.e., fast-acting fuse) to protect sensitive electrical components of the relay system 10.

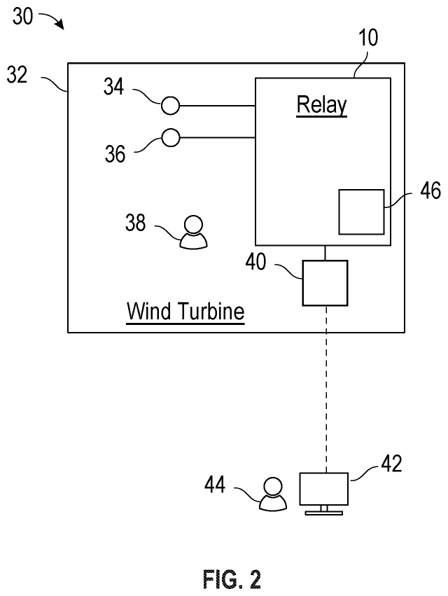

FIG. 2 illustrates an exemplary system 30 relating to some embodiments of the present disclosure. In some embodiments, the relay system 10 is integrated into a wind turbine 32, as shown. For example, the relay system 10 may be disposed within a compartment of the wind turbine 32 such as through mounting via a DIN connector within a battery or control compartment of the wind turbine 32. However, it should be understood that embodiments are contemplated for other applications in addition to wind turbines. For example, in some embodiments, the relay system 10 described herein may be deployed within a server system or another electric power/communication system.

In some embodiments, the relay system 10 may interface with an existing connection system of the wind turbine 32, such as an existing wiring harness in the compartment of the wind turbine 32. For example, at least one of the connection ports 24 may couple with a connection of the wiring harness of the wind turbine 32.

In some embodiments, the relay system 10 is coupled to or includes at least one temperature sensor 34. For example, the temperature sensor 34 may comprise any of a resistance temperature detector (RTD), a thermocouple, a thermistor, an infrared temperature sensor, or another suitable temperature sensor not explicitly described herein, as well as combinations thereof.

In some embodiments, the relay system 10 is coupled to or includes at least one voltage sensor 36. For example, the voltage sensor 34 may comprise any of a resistive, capacitive, or an inductive voltage sensor, as well as another suitable form of voltage sensor not explicitly described herein or combinations thereof. In some embodiments, the voltage sensor 36 may be coupled to one or more electronic components associated with the wind turbine 32. For example, embodiments are contemplated in which the voltage sensor 36 is coupled to an energy storage device of the wind turbine 32, such as any of a battery or ultracapacitor energy storage module of the wind turbine 32.

In some embodiments, the voltage sensor is operable to monitor voltage associated with either of an ultracapacitor or lead acid battery, as well as other forms of battery or capacitor. In some embodiments, a voltage monitoring input of the relay system 10 is operable to monitor voltages within a range of up to about 500 volts DC.

In some embodiments, an operator 38 may be on-site of the wind turbine 32, for example, to perform any of maintenance operations, installations, or other manual operations associated with the wind turbine 32. In some embodiments, as described above, the relay system 10 may include one or more indicator devices operable to communicate system information to the operator 38.

In some embodiments, the relay system 10 further includes or is coupled to a transceiver 40 such as a radio frequency transceiver operable to provide one-way, or bidirectional communication between the relay system 10 and one or more other remote components. For example, in some embodiments, the transceiver 40 is wirelessly communicatively coupled to at least one remote user device 42, such as a remote operator 44 is able to communicate with the relay system 10. For example, in some embodiments, the transceiver communicates via any form of network interface known in the art, such as Ethernet, ATM, fiber, Bluetooth®, or Wi-Fi (i.e., the IEEE 802.11 family of standards). In some embodiments, bi-directional communication is provided wirelessly such that the user device 42 and operator 44 are able to communicative with the relay system 10 remotely to provide control inputs to the relay system 10, such as, for example, to provide voltage or temperature set points or to receive remote alerts associated with the relay system 10.

In some embodiments, the relay system 10 is operable to provide remote monitoring of system components. For example, the relay system 10 may use the transceiver 40 to provide temperature monitoring of a compartment of the wind turbine 32 to the operator 44. In some embodiments, real-time monitoring is provided such that the operator 44 can remotely monitor the temperature and/or voltage within the wind turbine compartment in real-time. Additionally, embodiments are contemplated in which monitoring data is stored for later use. For example, a monitoring log may be included that tracks temperature and/or voltage information over time. Said monitoring data may be stored within a local data storage of the relay system 10 or remotely such via a cloud storage or on another remote device. Further, in some embodiments, monitoring data may be stored on an existing data storage component of the wind turbine.

In some embodiments, security measures may be included to prevent unintentional or malicious altering of relay settings. For example, in some embodiments, the relay system 10 programming and control may be password protected such that operators (remote or on-site) must provide a password or other positive identification to access or alter control settings and monitoring information.

In some embodiments, the relay system 10 further includes a control system 46. The control system 46, for example, may include one or more controllers, microcontrollers, control units, or other form of control/computing element. In some embodiments, the control system 46 includes at least one processor or microprocessor and a storage device, such as a computer-readable media for storing computer-readable instructions thereon.

In some embodiments, the control system 46 is coupled to one or more devices of the wind turbine 32 such as a heating system of the wind turbine 32 including one or more heating elements. The control system 46 may be operable to control and activate the one or more heating elements. In some embodiments, the control system 46 is operable to perform a heating test of the heating system. The heating test may be performed responsive to a heating test input, such as for example, a test input received remotely via the transceiver 40 or manually from an onsite operator (i.e., operator 38) via the one or more manual actuators 22.

In some embodiments, the heating test includes using the control system 46 to activate one or more heating elements of the wind turbine heating system and using the one or more temperature sensors 34 to monitor the temperature in the compartment of the wind turbine 32 after the heating elements have been activated to test the functionality of the heating system. Similarly, embodiments are contemplated for testing cooling functionality. For example, the wind turbine 32 may include a cooling system such as an air conditioning unit and or one or more fans or chillers, which may be tested similarly.

In some embodiments, the control system 46 is operable to generate one or more alerts responsive to a status of the wind turbine 32 or responsive to one or more monitored conditions, such as temperature or voltage. For example, the control system 46 may generate an alert responsive to determining that a temperature in the compartment is above a maximum temperature threshold or below a minimum temperature threshold. Similarly, minimum and maximum thresholds are contemplated for voltage alerts. The alerts generated by the control system 46 may be transmitted wirelessly such as using the transceiver 40 to transmit an alert to a remote user device (e.g., at least one remote user device 42). Alternatively, or additionally, the alert may be communicated onsite such as by using status indicators 20 or an audible alarm over a speaker of the wind turbine 32 or a speaker included on the relay system 10. Similarly, in some embodiments, alerts are contemplated for the tests described herein. For example, an alert may be generated responsive to a test being completed or responsive to a test being failed. For example, if one or more heating elements are determined to be compromised after testing, an alert may be generated and communicated to inform to operators (e.g., operator 38 or operator 44) that the heating test has been failed.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A monitoring system for a wind turbine, the monitoring system configured to be disposed in a compartment of the wind turbine and comprising:
one or more temperature sensors operable to measure a temperature within the compartment of the wind turbine;
one or more connections operable to interface with the compartment of the wind turbine; and
a manual test trigger operable to initiate a test routine of the monitoring system,
wherein the monitoring system is operable to receive a remote test input to initiate the test routine of the monitoring system,
wherein the monitoring system is operable to remotely receive one or more temperature set points.

2. The monitoring system of claim 1, further comprising:
a display operable to display information indicative of the temperature within the compartment of the wind turbine.

3. The monitoring system of claim 2, wherein the display comprises a thin film transistor screen.

4. The monitoring system of claim 1, further comprising:
one or more status indicators operable to illuminate responsive to a status of the monitoring system.

5. The monitoring system of claim 1, further comprising:
one or more voltage sensors operable to measure a voltage within the compartment of the wind turbine.

6. The monitoring system of claim 1, wherein the one or more connections are configured to interface with an existing wiring harness in the compartment of the wind turbine.

7. The monitoring system of claim 6, further comprising:
a mount coupled to a housing of the monitoring system, the mount configured to interface with a rail of the compartment of the wind turbine to support the monitoring system thereon.

8. A monitoring system for a wind turbine, the monitoring system configured to be disposed in a compartment of the wind turbine and comprising:
one or more voltage sensors operable to measure a voltage within the compartment of the wind turbine; and
one or more connections operable to interface with the compartment of the wind turbine,
wherein the monitoring system is operable to receive one or more voltage set points.

9. The monitoring system of claim 8, further comprising:
a display operable to display information indicative of a temperature within the compartment of the wind turbine.

10. The monitoring system of claim 9, wherein the display comprises a liquid crystal display readout.

11. The monitoring system of claim 8, further comprising:
one or more status indicators operable to illuminate responsive to a status of the monitoring system.

12. The monitoring system of claim 8, further comprising:
one or more temperature sensors operable to measure a temperature within the compartment of the wind turbine.

13. The monitoring system of claim 8, further comprising:
a housing supporting the one or more connections thereon.

14. The monitoring system of claim 13, further comprising:
a mount disposed on a rear surface of the housing, the mount configured to interface with a rail of the compartment of the wind turbine to support the monitoring system thereon.

15. A monitoring system for a wind turbine, the monitoring system configured to be disposed in a compartment of the wind turbine and comprising:
one or more temperature sensors operable to measure a temperature within the compartment of the wind turbine;
one or more voltage sensors operable to measure a voltage within the compartment of the wind turbine; and
one or more connections operable to interface with the compartment of the wind turbine,
wherein the monitoring system is operable to receive one or more temperature set points and one or more voltage set points.

16. The monitoring system of claim 15, further comprising:
a wireless transceiver operable to receive the one or more temperature set points and the one or more voltage set points from a remote user device.

17. The monitoring system of claim 16, wherein the wireless transceiver provides a bidirectional communication connection with the remote user device.

18. The monitoring system of claim 17, wherein the wireless transceiver is operable to transmit one or more status signals comprising information indicative of a status of the monitoring system to the remote user device over the bidirectional communication connection.

19. The monitoring system of claim 18, further comprising:
one or more manual actuators operable to receive one or more temperature set points and one or more voltage set points manually from an onsite operator.

20. The monitoring system of claim 15, further comprising:
a control system operable to perform a heating test responsive to a heating test input, wherein the heating test includes:
using the control system to activate one or more heating elements of the wind turbine; and
using the one or more temperature sensors to measure the temperature within the compartment of the wind turbine after the one or more heating elements are activated.
